(19) United States
(12) Patent Application Publication
(10) Pub. No.: US 2002/0154358 A1
(43) Pub. Date: Oct. 24, 2002

(54) Clock synchronization supervisory method of OSC signal in wavelength multiplexing system and wavelength multiplexing system using that method

(75) Inventor: Masataka Hino, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/127,444

(22) Filed: Apr. 23, 2002

(30) Foreign Application Priority Data
Apr. 24, 2001 (JP) 2001-125343

(51) Int. Cl. H04J 14/02; H04B 10/00

(52) U.S. Cl. 359/124; 359/158

(57) ABSTRACT

To provide a clock synchronization supervisory method of an OSC signal in a wavelength multiplexing system whereby, in the case where a slip alarm is generated by transmission line trouble, optimum clock synchronization supervision in OSC communication is performed by masking this slip alarm. A clock synchronization supervisory method of the OSC signal has a configuration wherein, in the wavelength multiplexing system for transferring a management message and user data among sequentially connected apparatuses by clock-synchronized OSC communication, each apparatus supervises clock synchronization and inserts slip alarm mask information into the OSC signal when transmission line trouble occurs so as to send it to an opposite apparatus, and the opposite apparatus takes out the slip alarm mask information from the received OSC signal and masks the slip alarm.

### BACKGROUND OF THE INVENTION

1. Field of the Invention

The present invention relates to a technology for supervising clock synchronization in a wavelength multiplexing system.

2. Description of the Prior Art

In the past, a subnetwork of a wavelength multiplexing system for implementing a transfer of a management message and user data among apparatuses by communication of an OSC signal (Optical Supervisory channel) had a configuration as shown in FIG. 3, for instance.

In FIG. 3, a subnetwork 900 has a plurality of sequentially connected apparatuses, that is, the three apparatuses A, B and C in the case shown therein, and these apparatuses A, B and C have amplifiers for two-way communication 910A, 920A, 910B, 920B, 910C and 920C respectively.

And the apparatus A is set in an INT mode as a clock master, whereas the apparatuses B and C are set in an SLV mode to be In slave synchronization with the apparatus A.

Thus, the apparatus A has the amplifier 910A in operation based on a clock signal generated by the apparatus A itself, and the apparatuses B and C operate in synchronization with the clock signal sent together with the OSC signal from the amplifier 910A of the apparatus A via a transmission line.

Incidentally, in the case trouble occurs on the transmission line in one direction from the apparatus A to the apparatus B as shown in FIG. 4 for instance, the apparatuses B and C located downstream on the transmission line no longer have the clock signal of the apparatus A transmitted thereto, and so it is no longer available to them.

For this reason, the apparatus B is switched from the SLV mode to the INT mode to become a new clock master, and the apparatus C operates in synchronization with the clock signal of the apparatus B as it is transmitted thereto.

Thus, new clock synchronization is established between the apparatuses B and C.

At this time, however, the transmission line in one direction from the apparatus B to the apparatus A is active, and so the OSC signal is sent from the apparatus B to the apparatus A. On that occasion, the apparatus B is in operation in synchronization with its own clock signal, and so the OSC signal transmitted from the apparatus B to the apparatus A is in synchronization with the clock signal of the apparatus B.

Accordingly, the clock synchronization between the apparatus A and the apparatus B is no longer established, and a so-called slip alarm, which is a secondary and unnecessary alarm generated by transmission line trouble is generated in the apparatus A.

### BRIEF SUMMARY OF THE INVENTION

The present invention has been implemented in order to solve the above problem, and an object thereof is to provide a clock synchronization supervisory method of an OSC signal in a wavelength multiplexing system whereby, in the case where a slip alarm is generated by transmission line trouble, optimum clock synchronization supervision in OSC communication is performed by masking this slip alarm.

To attain this object, the clock synchronization supervisory method of the OSC signal according to claim 1 of the present invention has a configuration wherein, in the wavelength multiplexing system for transferring a management message and user data among sequentially connected apparatuses by clock-synchronized OSC communication, each apparatus supervises clock synchronization and inserts slip alarm mask information into the OSC signal when transmission line trouble occurs so as to send it to an opposite apparatus, and the opposite apparatus takes out the slip alarm mask information from the received OSC signal and masks the slip alarm.

If the clock synchronization supervisory method of an OSC signal has such a configuration, the slip alarm mask information is inserted into the OSC signal when transmission line trouble occurs and it is sent to the opposite apparatus, so that the opposite apparatus takes out the slip alarm mask information from the received OSC signal and masks the slip alarm based on this slip alarm mask information. Thus, when the transmission line trouble occurs, occurrence of the slip alarm which is secondary and unnecessary alarm generated by the transmission line trouble is deterred. Accordingly, it is possible, as the slip alarm which is the unnecessary alarm is not generated, to supervise the clock synchronization of the OSC signal more adequately and also to perform optimum maintenance.

The clock synchronization supervisory method of the OSC signal according to claim 2 has a configuration wherein each apparatus has an OSC signal processing division, and this OSC signal processing division inserts the slip alarm mask information into the OSC signal when the transmission line trouble occurs so as to send it to the opposite apparatus, and takes out the slip alarm mask information from the received OSC signal and masks the slip alarm.

If the clock synchronization supervisory method of the OSC signal has such a configuration, it is possible, by means of the OSC signal processing division, to insert the slip alarm mask information on occurrence of the transmission line trouble, take out the slip alarm mask information from the received OSC signal and mask the slip alarm.

The clock synchronization supervisory method of the OSC signal according to claim 3 has a configuration wherein the above described OSC signal processing division detects the transmission line trouble based on the received OSC signal, and inserts the slip alarm mask information into the OSC signal to be sent and sends it.

If the clock synchronization supervisory method of the OSC signal has such a configuration, the OSC signal processing division of each apparatus can receive the OSC signal sent from the apparatus on an upstream side and detect the transmission line trouble based on this OSC signal so as to insert the slip alarm mask information into the OSC signal to be sent respectively, where each apparatus detects the transmission line trouble and the slip alarm mask information is inserted into the OSC signal on the occurrence of the transmission line trouble, so that it can deter occurrence of the slip alarm in another apparatus.

The clock synchronization supervisory method of the OSC signal according to claim 4 has a configuration wherein the above described OSC signal processing division switches the apparatus from an SLV mode to an INT mode on detecting the transmission line trouble from the received OSC signal.

If the clock synchronization supervisory method of the OSC signal has such a configuration, the apparatus detecting the transmission line trouble on its occurrence is switched from the SLV mode to the INT mode so that the apparatus becomes a new clock master to generate a clock signal and sends the OSC signal based on this clock signal.

The clock synchronization supervisory method of the OSC signal according to claim 5 has a configuration wherein the above described OSC signal processing division masks a slip alarm occurrence when the slip alarm mask information is inserted in the received OSC signal.

If the clock synchronization supervisory method of the OSC signal has such a configuration, the OSC signal processing division masks the slip alarm occurrence when the slip alarm mask information is inserted in the received OSC signal, so that it can deter occurrence of the slip alarm which is the unnecessary alarm on the occurrence of the transmission line trouble. It is thereby possible to supervise the clock synchronization of the OSC signal more adequately and also to perform optimum maintenance.

The clock synchronization supervisory method of the OSC signal according to claim 6 has a configuration wherein the above described OSC signal processing division analyzes the received OSC signal so as to take out and exploit the management message and the user data.

If the clock synchronization supervisory method of the OSC signal has such a configuration, the OSC signal processing division of each apparatus can take out and exploit the management message and the user data as appropriate from the received OSC signal.

Moreover, the wavelength multiplexing systems according to claims 7 to 12 have the same effects as the clock synchronization supervisory methods of the OSC signal according to claims 1 to 6.

### BRIEF DESCRIPTION OF THE DRAWINGS

FIG. 1 is a block diagram showing a configuration of a subnetwork of a wavelength multiplexing system to which an embodiment of a clock synchronization supervisory method of an OSC signal of the present invention is applied;

FIG. 2 is a block diagram showing a configuration of an OSC signal processing division of each apparatus in the subnetwork in FIG. 1;

FIG. 3 is a block diagram showing a configuration of the subnetwork in the wavelength multiplexing system of the past; and

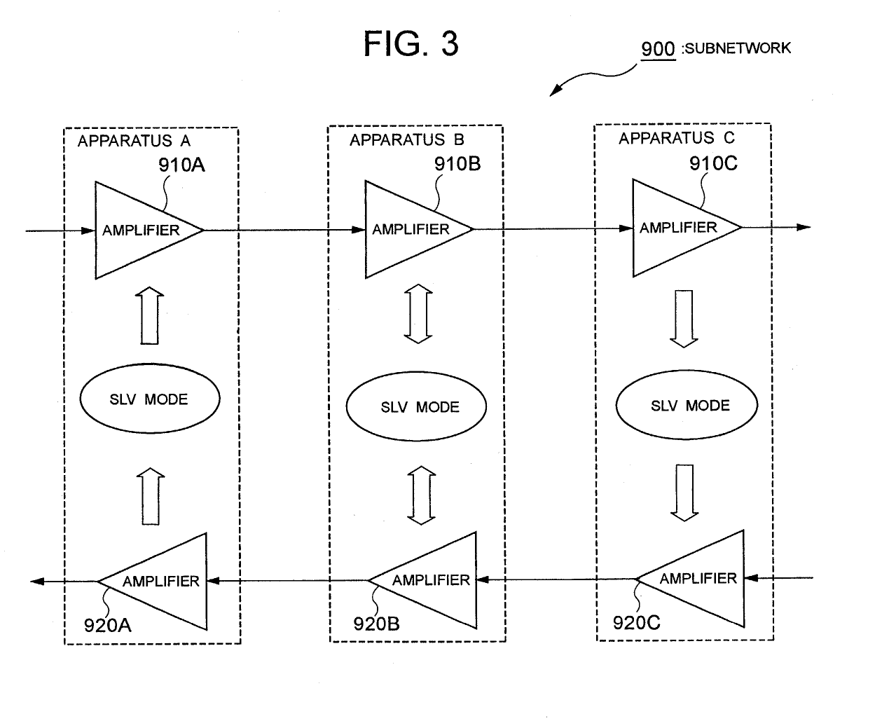

FIG. 4 is a block diagram showing a state of occurrence of transmission line trouble in the subnetwork in the wavelength multiplexing system in FIG. 3.

### DETAILED DESCRIPTION OF THE PREFERRED EMBODIMENTS

Hereafter, the embodiments of the present invention will be described by referring to the drawings.

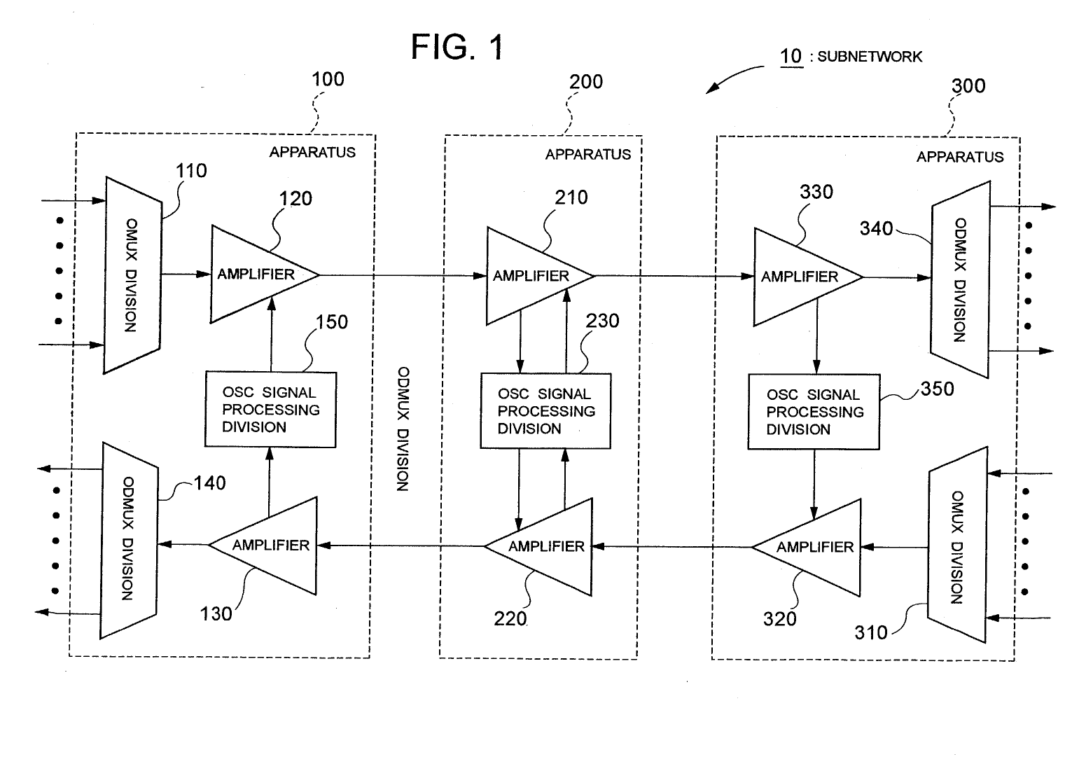

First, a subnetwork of a wavelength multiplexing system to which an embodiment of a clock synchronization supervisory method of an OSC signal of the present invention is applied will be described by referring to FIG. 1.

FIG. 1 is a block diagram showing a configuration of the above subnetwork.

As shown in FIG. 1, a subnetwork 10 has three apparatuses 100, 200 and 300 sequentially connected by a transmission line provided thereon.

In FIG. 1, the first apparatus 100 at the left end has an OMUX division 110, an amplifier for transmission 120, an amplifier on a receiving side 130, an ODMUX division 140 and an OSC signal processing division 150 provided thereon.

In addition, a second apparatus 200 in the middle has two amplifiers 210 and 220, and an OSC signal processing division 230 provided thereon in FIG. 1.

In this case, the two amplifiers 210 and 220 work as the amplifiers on a sending side and the receiving side respectively, and they mutually perform demultiplexing, processing and multiplexing of the OSC signals to the OSC signal processing division 230 bi-directionally.

Furthermore, in FIG. 1, the third apparatus 300 at the right end has an OMUX division 310, an amplifier on the sending side 320, an amplifier on the receiving side 330, an ODMUX division 340 and an OSC signal processing division 350 provided thereon, as with the above-mentioned first apparatus 100.

Here, the above OMUX divisions 110 and 310 wavelength-multiplex a plurality of inputted signals and output them as one signal.

In addition, the amplifiers 120 and 320 on the sending side amplify the signals from the OMUX divisions 110 and 310, and also multiplex the OSC signals from the OSC signal processing divisions 150 and 350 and output them to the apparatus 200.

As opposed to this, the amplifiers on the receiving side 130 and 330 amplify the signals inputted from the apparatus 200, and also demultiplex the OSC signals included in the signals and output them to the OSC signal processing divisions 150 and 350.

Furthermore, the ODMUX divisions 140 and 340 demultiplex the signals from the amplifiers on the receiving side 130 and 330 and output each of them separately.

In addition, the first amplifier 210 of the two amplifiers 210 and 220 of the second apparatus 200, amplifies the signals inputted from the first apparatus 100, and further demultiplexes the OSC signals included in the signals and outputs them to the OSC signal processing division 230, and also multiplexes the OSC signals from the OSC signal processing divisions 230 and outputs them to the third apparatus 300.

As opposed to this, the second amplifier 220 amplifies the signals inputted from the third apparatus 300, and further demultiplexes the OSC signals included in the signals and output them to the OSC signal processing divisions 230, and also multiplexes the OSC signals from the OSC signal processing divisions 230 and outputs them to the first apparatus 100.

Here, the above amplifiers 120, 130, 210, 220, 320, 330, and the OMUX divisions 110 and 310, and the ODMUX divisions 140 and 340 used herein are the ones of publicly known configurations respectively, and so detailed description thereof will be omitted.

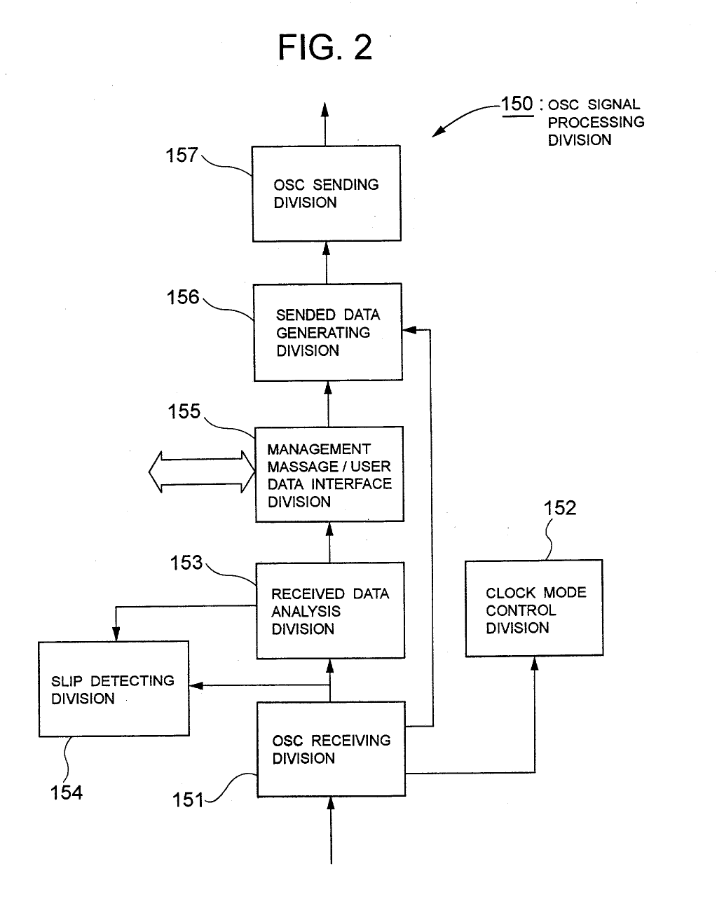

As the above OSC signal processing divisions 150 and 350 have the same configuration, the OSC signal processing division 150 will be described hereafter by referring to FIG. 2.

The above OSC signal processing division 150 has an OSC receiving division 151, a clock mode control division 152, a received data analysis division 153, a slip detecting division 154, a management message/user data interface division 155, a sended data generating division 156 and an OSC sending division 157 provided therein.

The above OSC receiving division 151 receives the OSC signals demultiplexed by the amplifier on the receiving side 130 and outputs it to the received data analysis division 153, and also detects transmission line trouble.

And in the case where the transmission line trouble is detected, the OSC receiving division 151 notifies the clock mode control division 152 and the sended data generating division 156 thereof.

When notified of detection of the transmission line trouble from the OSC receiving division 151, the above clock mode control division 152 switches a clock mode of the apparatus 100 from an SLV mode to an INT mode.

The above received data analysis division 153 analyzes the OSC signals inputted from the OSC receiving division 151 and supervises clock synchronization, and also sends analyzed data to the management message/user data interface division 155.

Furthermore, in the case where the above received data analysis division 153 has taken out slip alarm mask information inserted into the OSC signals by data analysis, the received data analysis a division 153 notifies it to the above slip detecting division 154.

When notified of detection of the slip alarm mask information from the received data analysis division 153, the above slip detecting division 154 masks a slip alarm generated by the OSC receiving division 151.

The above management message/user data interface division 155 receives the data (management message/user data) analyzed by the received data analysis division 153, and exploits and appropriately corrects it as required.

And the management message/user data interface division 155 sends the management message/user data as a result of exploitation to the sended data generating division 156.

The above sended data generating division 156 generates the OSC signals as sended data based on the management message/user data from management message/user data interface division 155, and inserts the slip alarm mask information into the above OSC signals on receipt of notification of detection of the transmission line trouble from the OSC receiving division 151.

The above OSC sending division 157 sends the OSC signals from the sended data generating division 156 to the amplifier 120 on the sending side of the transmission line.

The OSC signal processing division 350 also operates in the same way as the above-mentioned OSC signal processing division 150, and the OSC signal processing division 230 operates in the same way as the OSC signal processing division 150 bi-directionally between the two amplifiers 210 and 220.

Next, the clock synchronization supervisory method of the OSC signal according to the present invention in the subnetwork 10 of the above-mentioned wavelength multiplexing system will be described.

In FIG. 1, the apparatus 100 is set in the INT mode as a clock master, and the apparatuses 200 and 300 are set in the SLV mode to be in slave synchronization with the apparatus 100.

Thus, the apparatus 100 has the amplifier 120 on the sending side in operation based on a clock signal generated by the apparatus 100 itself to amplify wavelength multiplexing signals from the OMUX division 110, and also multiplexes the OSC signals from the OSC signal processing divisions 150 and outputs them to the apparatus 300 via the apparatus 200.

And in the apparatus 300, the ODMUX division 340 demultiplexes the signals which are wavelength-multiplexed and output from the amplifier 330 on the receiving side and outputs each of them separately.

In this case, the apparatuses 200 and 300 are to be in slave synchronization based on the clock signal included in the transmitted OSC signal.

Likewise, based on the received clock signal of the apparatus 100, in the apparatus 300, the amplifier on the sending side 320 amplifies the wavelength multiplexing signals from the OMUX division 310, and also multiplexes the amplified signals and the OSC signals from the OSC signal processing divisions 350, and transfers them to the apparatus 100 via the apparatus 200.

And in the apparatus 100, the ODMUX division 140 demultiplexes the signals which are the output signals from the amplifier 130 on the receiving side and outputs each of them separately.

In this case, the apparatus 200 is to be in slave synchronization based on the clock signal included in the transmitted OSC signal, and the apparatus 100 is to be in synchronization with the clock signal generated by the apparatus 100 itself.

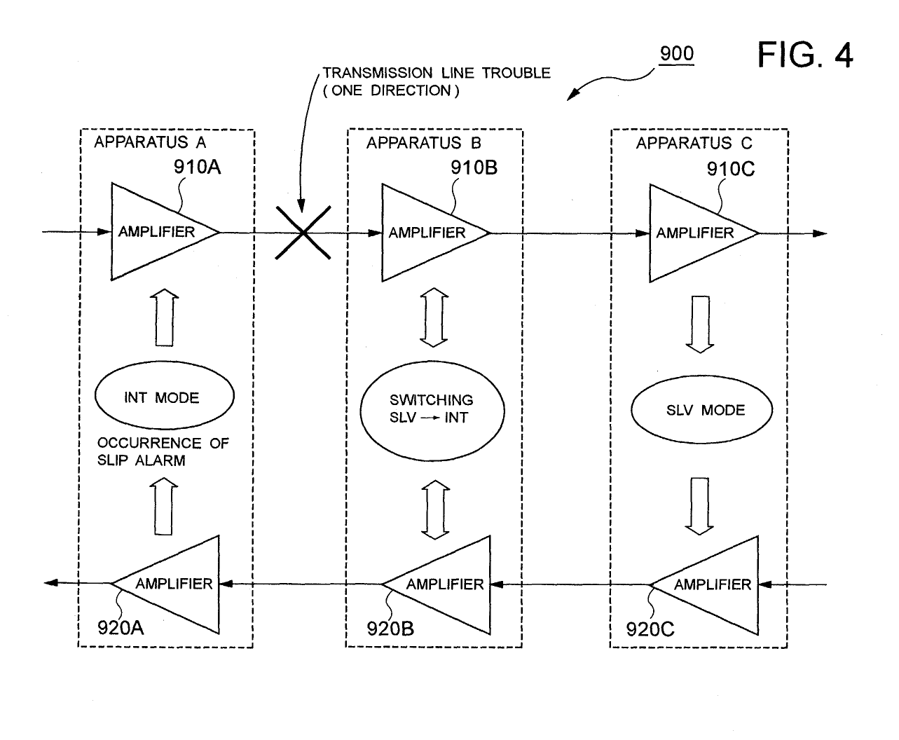

Here, if trouble occurs on the transmission line in one direction from the apparatus 100 to the apparatus 200 as shown in FIG. 4 for instance, the apparatus 200 located downstream on this transmission line no longer has the clock signal of the apparatus 100 transmitted thereto.

For this reason, in the OSC signal processing division 230 of the apparatus 200, the clock mode control division 152 switches the clock mode from the SLV mode to the INT mode. Then, the apparatus 200 becomes a new clock master, and the apparatus 300 has the clock signals of the apparatus 200 transmitted thereto.

Thus, new clock synchronization is established and signal transmission is performed between the apparatuses 200 and 300.

On that occasion, the OSC signal processing division 230 generates the OSC signals by inserting slip alarm mask information therein.

Incidentally, the OSC signals are transmitted from the apparatus 200 to the transmission line between the apparatus 200 and the apparatus 100 based on the clock signals of the apparatus 200, and so the clock synchronization between the apparatus 100 and the apparatus 200 is no longer established and a slip occurs, and yet the OSC signal from the apparatus 200 has the slip alarm mask information inserted therein.

Accordingly, this slip alarm mask information is taken out in the OSC signal processing divisions 150 of the apparatus 100 so as to mask the occurrence of the slip alarm.

Thus, the occurrence of the slip alarm which is a secondary and unnecessary alarm due to the occurrence of the transmission line trouble is deterred, so that it is possible to supervise the clock synchronization more adequately.

As described above, according to a mobile communication system 40 of the embodiment of the present invention, a mobile station 400 located in a service area of the radio station 410 acquires a sending radio wave from the adjacent radio station 410 capable of service, and performs communication therewith so as to thereby engage in calls and so on without being influenced by stop of the service of the radio station 410.

Thereafter, if a radio station interface line 430 recovers from trouble, a line trouble supervisory function division 411 of the radio station 410 detects a state of recovery from the trouble, and the line trouble supervisory function division 411 notifies a sending power control function division 412 of recovery information.

On receipt of this, the sending power control function division 412 exerts control to return sending power of the radio wave to be sent to the service area to a normal level, and the radio station 410 thereby renders the sending power of the sending radio wave to the service area to a normal level.

Accordingly, the mobile station 400 located in the service area of the radio station 410 can engage in calls more securely by performing the communication with the nearest radio station 410 again.

In the above-mentioned embodiment, while the subnetwork 10 has one relay apparatus 200 provided between the apparatuses 100 and 300 mutually sending and receiving the signals, it should not be limited to it but a plurality of relay apparatuses may be sequentially provided thereon.

As described above, according to the present invention, the slip alarm mask information is inserted into the OSC signal when the transmission line trouble occurs and it is sent to the opposite apparatus, so that the opposite apparatus takes out the slip alarm mask information from the received OSC signal and masks the slip alarm based on this slip alarm mask information. Thus, when the transmission line trouble occurs, the occurrence of the slip alarm which is secondary and unnecessary alarm generated by the transmission line trouble is deterred. Accordingly, it is possible, as the slip alarm which is the unnecessary alarm is not generated, to supervise the clock synchronization of the OSC signal more adequately and also to perform optimum maintenance.

Thus, it is possible, in the case where the slip alarm is generated by the transmission line trouble, to perform optimum clock synchronization supervision in OSC communication by masking this slip alarm.

What is claimed is:

1. A clock synchronization supervisory method of an OSC signal in a wavelength multiplexing system for transferring a management message and user data among sequentially connected apparatuses by clock-synchronized OSC communication, wherein:
each apparatus supervises clock synchronization, and when transmission line trouble occurs, inserts slip alarm mask information into the OSC signal so as to send it to an opposite apparatus; and
the opposite apparatus takes out the slip alarm mask information from the received OSC signal and masks a slip alarm.

2. The clock synchronization supervisory method of the OSC signal in the wavelength multiplexing system according to claim 1, wherein each apparatus has an OSC signal processing division, and this OSC signal processing division inserts the slip alarm mask information into the OSC signal when the transmission line trouble occurs so as to send it to the opposite apparatus, and takes out the slip alarm mask information from the received OSC signal and masks a slip alarm.

3. The clock synchronization supervisory method of the OSC signal in the wavelength multiplexing system according to claim 2, wherein said OSC signal processing division detects the transmission line trouble based on the received OSC signal, and inserts the slip alarm mask information into the OSC signal to be sent and sends it.

4. The clock synchronization supervisory method of the OSC signal in the wavelength multiplexing system according to claim 2, wherein said OSC signal processing division switches the apparatus from an SLV mode to an INT mode on detecting the transmission line trouble from the received OSC signal.

5. The clock synchronization supervisory method of the OSC signal in the wavelength multiplexing system according to claim 2, wherein said OSC signal processing division masks a slip alarm occurrence when the slip alarm mask information is inserted in the received OSC signal.

6. The clock synchronization supervisory method of the OSC signal in the wavelength multiplexing system according to claim 2, wherein said OSC signal processing division analyzes the received OSC signal so as to take out and exploit the management message and the user data.

7. A wavelength multiplexing system for transferring a management message and user data among sequentially connected apparatuses by clock-synchronized OSC communication, wherein each apparatus supervises clock synchronization and has:
slip alarm mask information inserting means for inserting slip alarm mask information into an OSC signal when transmission line trouble occurs so as to send it to an opposite apparatus; and
slip alarm mask means for receiving the OSC signal in which said slip alarm mask information is inserted, taking out said slip alarm mask information therefrom and masking a slip alarm.

8. The wavelength multiplexing system according to claim 7, wherein said each apparatus has an OSC signal processing division, and said OSC signal processing division includes said slip alarm mask information inserting means and said slip alarm mask means.

9. The wavelength multiplexing system according to claim 8, wherein said OSC signal processing division detects the transmission line trouble based on the received OSC signal, and inserts said slip alarm mask information into the OSC signal to be sent and sends it.

10. The wavelength multiplexing system according to claim 8, wherein said OSC signal processing division switches the apparatus from an SLV mode to an INT mode on detecting the transmission line trouble from the received OSC signal.

11. The wavelength multiplexing system according to claim 8, wherein said OSC signal processing division masks a slip alarm occurrence when said slip alarm mask information is inserted in the received OSC signal.

12. The wavelength multiplexing system according to claim 8, wherein said OSC signal processing division analyzes the received OSC signal so as to take out and exploit the management message and the user data.
